(19) United States
(12) Patent Application Publication
(10) Pub. No.: US 2014/0166132 A1
(43) Pub. Date: Jun. 19, 2014

(54) INPUT EXPANSION UNIT

(71) Applicant: ARROW ENGINE COMPANY, Tulsa, OK (US)

(72) Inventors: Casey D. Roberts, Broken Arrow, OK (US); Jamey Jameson, Broken Arrow, OK (US); Billie E. Baker, Bixby, OK (US)

(73) Assignee: ARROW ENGINE COMPANY, Tulsa, OK (US)

(21) Appl. No.: 13/715,435

(22) Filed: Dec. 14, 2012

(51) Int. Cl. F17C 5/06

(52) U.S. Cl. CPC F17C 5/06
USPC 137/557

(57) ABSTRACT

A oil and gas compression system is generally presented. The compression system includes a driver, a driver starter, and an input expansion unit. The expansion unit may include a plurality of inputs configured to receive feedback from the compression system, a processor configured to receive the plurality of inputs and send an output signal to the driver starter to start or stop the driver, and an indication panel configured to indicate the presence of an input condition. The input expansion unit may be configured to store a history of received input conditions and display the history on the indication panel upon request.

### FIELD OF INVENTION

The present invention relates generally to an expansion input monitoring unit for monitoring fault conditions on a compression unit, such as a natural gas compression system.

### BACKGROUND

Natural gas is found beneath deep underground rock formations. Traditionally, natural gas is transported in large quantities, frequently over distances of several thousand kilometers in large gas pipelines to the centers of consumption. Such long-distance gas pipelines may be operated with high gas pressures in order to achieve a transportation capacity which is as large as possible. To compensate for the unavoidable pressure loss along the gas pipelines, compressor stations must be provided at certain intervals for increasing the gas pressure back to the nominal pressure. Compressor stations may also be placed near natural gas collection areas to direct flow into pipelines. Additionally, vapor recovery units may be placed at or near collection areas to reclaim natural gas vapors that would otherwise escape into the atmosphere.

Compression systems, such as compressor stations and vapor recovery units, used in the oil and gas industry often include driver or motor to power a compressor. The driver is generally controlled by a driver starter unit. The driver starter unit may comprise a basic arrangement, such as a key and ignition, or a more complex system, such as an automated starter unit. Automated starter units commonly monitor and receive inputs from the compression unit. Such inputs may include a remote start signal, oil pressure, engine temperature, emergency stop button, magnetic pickup from the driver, auxiliary shutdown, and other analog or digital inputs.

Most driver starter units, however, suffer from several drawbacks. First, crude systems, such as key and ignition systems, do not provide any available inputs or driver control. Second, automated driver units are often limited in the number of inputs that they have, leading to multiple inputs being arranged in series and other various undesirable wiring solutions. Further, many driver systems lack capabilities to track input history which often help in determining the cause of a shutdown or fault in the system. Retrofitting such both crude and automated driver systems can be difficult due to design constraints such as hazardous area requirements for non-sparking components and enclosures and the lack of feasible integration points.

Accordingly, an improved input expansion unit is needed in the industry.

### SUMMARY

A gas and oil compression system includes a driver and a driver starter. The driver may drive a compressor unit. The compression system may include an input expansion unit in communication with the driver starter. The expansion unit may comprise a plurality of inputs configured to receive feedback from the compression system, and a processor configured to receive the plurality of inputs and send an output signal to the driver starter to start or stop the driver in response to a input signal. The expansion unit may further include an indication panel configured to indicate the presence of an input condition. The input expansion unit may store a history of received input conditions and display the history on the indication panel upon request.

In an embodiment, the expansion module may include a plurality of opto-couplers to optically isolate the inputs from the processor. The opto-couplers may electrically isolate the processor from the input devices to reduce the risk of a spark. The opto-couplers may further isolate the processor from unwanted electrical noise.

### DESCRIPTION OF THE DRAWINGS

Operation of the invention may be better understood by reference to the following detailed description taken in connection with the following illustrations, wherein:

FIG. 1 is a perspective view of a compressor system.

FIG. 2 is a block diagram of an input expansion unit.

FIG. 3 is a display plate having input indicators.

FIG. 4 is a circuit diagram of an input expansion module.

FIG. 5 is a block diagram of stacked input expansion modules.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

A compression system 10 for use in the oil and gas industry is generally presented. The compression system 10 may be utilized to compress or reclaim resources, such as natural gas, from below the earth's surface.

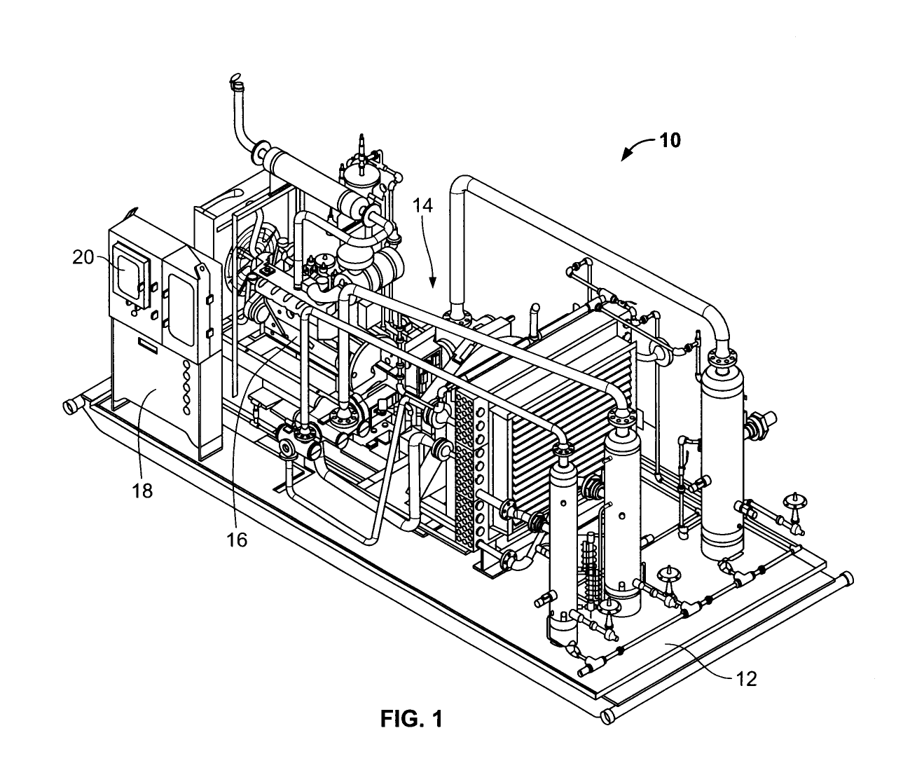

With reference to FIG. 1, a compression system 10 is shown. The compression system 10 may include a base or skid 12. The base 12 may support components of the compressions system 10 and may be located near a natural gas recovery area. The compression system 10 may include a plurality of components, as further described below, all supported on the base 12. Alternatively, the system components may be configured without a base and arranged in direct contact with the ground.

As shown in FIG. 1, the compression system 10 may include a compressor 14. The compressor may be utilized to compress natural gas pockets underground or inside pipelines to direct the gas into and through the pipelines. In the case of a vapor recovery unit, the compressor 14 may be utilized to assist in recovering gases that would otherwise escape into the atmosphere. The compressor 14 may include a driver 16 to drive the compressor. The driver 16 may comprise a motor, such as an electric motor, or any other type of motor known in the art. In an embodiment, the driver 16 may comprise a natural gas engine configured to run on natural gas recovered from the ground.

The compression system 10 may include a control panel 18. The control panel 18 may generally receive inputs to monitor the status of components of the compression system 10 and control the compressor driver 16. The control panel may include gauges and sensors to monitor parameters such as oil pressure, engine temperature, and other various system parameters.

The control panel 18 may include a driver starter 20. The driver starter 20 may comprise a device configured to start and stop the driver 16. In an embodiment, the driver starter 20 may be a simple ignition key switch to turn the driver 16 on and off. The ignition key switch can be manually turned on and off but is not capable of monitoring various input parameters. In another embodiment, the driver starter 20 may comprise a push button starter and a motor starter relay. The push button may activate the motor starter relay to turn on the driver 16. The motor starter relay may receive one or more hard wired inputs, such as an emergency stop button, over pressure switch or over temperature switch, from the compression system 10. The motor starter may disengage and cut power to the driver 16 in response to a change in status of any of the inputs. In an embodiment, a plurality of inputs may be wired in series and act as a single input to the driver starter 20.

In an embodiment, the driver starter 20 may be an automated starter. The automated starter 20 may be configurable or programmable to control the driver 16 based on user selected parameters. For example, the automated starter 20 may receive a plurality of inputs to monitor conditions of the compression system 10. The inputs may include oil pressure, engine temperature, auxiliary shutdown, remote start signal, motor encoder input, emergency stop input, and other analog and digital inputs. The starter 20 may further include one or more output channels. The outputs may include an idle signal to the driver, a clutch signal, an alarm or buzzer, crank or engine start signal, and engine stop signal.

The driver starter 20 may include an interface to allow a user to configure certain parameters. For example, the driver starter 20 may include an LCD or LED display, keypad, keyboard, touchscreen, or other similar interface components. The driver starter may allow a user to configure specific parameters, such as an engine oil pressure limit (high and low), an engine high temperature limit, driver speed limits, or other limits and timers. The driver starter 20 may then be configured to stop or start the driver 16 in response to an over-limit condition or expiration of a timer.

The automated driver starter 20 may be configured to stop or cut power to the driver 16 in response to other system inputs, such as the emergency stop or other pressure or temperature sensors within the system. The automated driver starter 20 may have a limited number of input channels, such as a total of four available input channels. Therefore, in order to receive all the input signals related to system fault conditions, a plurality of inputs may be wired in parallel to the auxiliary input of the starter 20. The automated starter 20 may then be configured to cut power to the driver 16 in response to a change in status of any of the fault condition inputs. This arrangement, however, does not allow the driver starter 20 to determine which specific input has been triggered causing the driver 16 to stop, thus making troubleshooting and diagnosing problems within the system much more difficult.

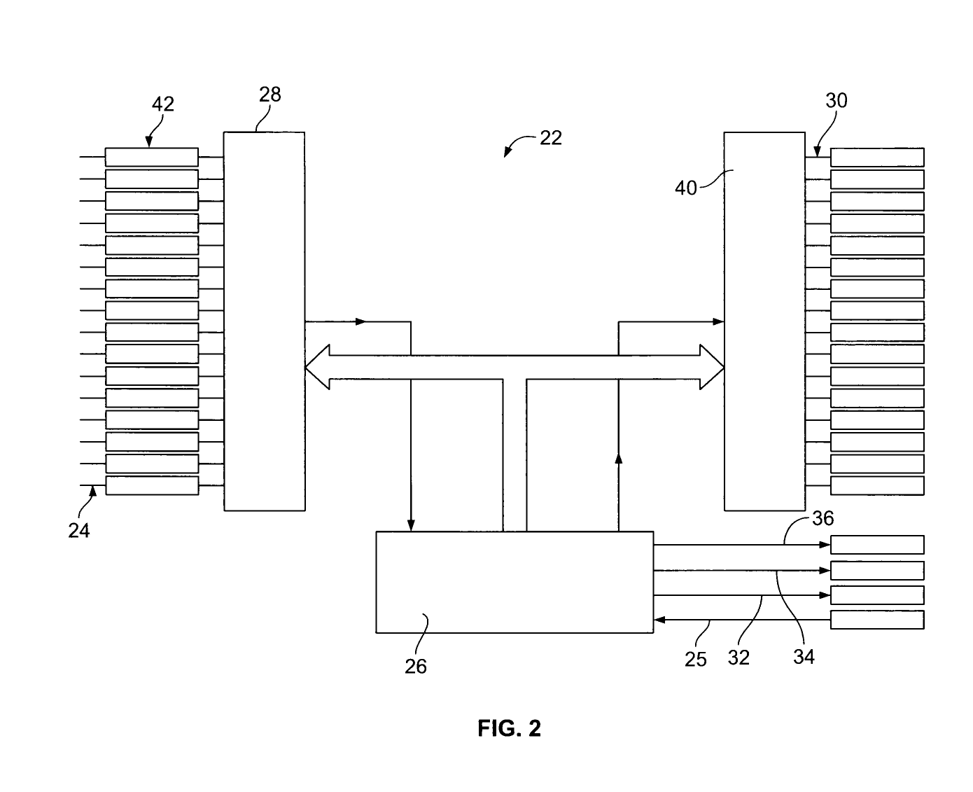

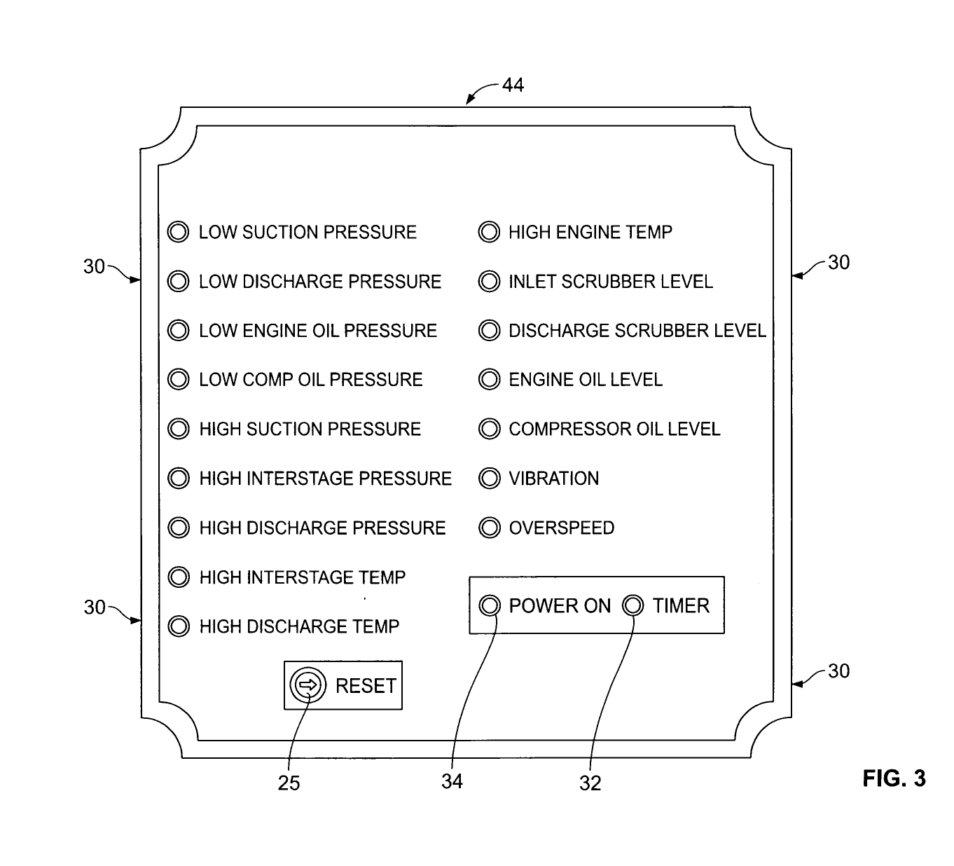

The compression system 10 may include an input expansion unit 22, as set forth in FIGS. 2-5. The expansion unit 22 may allow the compression system 10 to receive additional inputs related to monitoring and the compression system 10. The input expansion unit 22 may interface directly with the driver starter 20 to enhance control of the driver 16 and provide additional feedback information.

The expansion unit 22 may be mountable within an enclosure. For example, the expansion unit may be mounted in its own enclosure, separate from the driver starter 20 and control panel 18. Alternatively, the expansion unit 22 may be mounted in the same enclosure as the driver starter 20.

As illustrated in FIG. 2, the expansion unit 22 may include a plurality of inputs 24. The inputs 24 may be hard wired to the expansion unit 22. In an embodiment, the expansion unit 22 may include 16 inputs on a single unit. However, it will be appreciated that any appropriate number of inputs may be included on the expansion unit 22.

The inputs 24 may sense and monitor components of the compression system 10 to determine the presence of a fault or unwanted condition. By way of a non-limiting example, the inputs may monitor suction pressure (high or low), discharge pressure (high or low), low engine oil pressure, low compressor oil pressure, high interstage pressure, high interstage temperature, high discharge temperature, high engine temperature, inlet scrubber level, discharge scrubber level, engine oil level, compressor oil level, vibration, and overspeed. The expansion unit 22 may further include a reset button input 25.

The inputs may be wired directly or indirectly to a processor or microcontroller 26. The processor 26 may be any appropriate processor or microcontroller designed to receive the necessary inputs and process the necessary outputs. As an illustrative example, the processor 26 may be a 18FH520 Microchip Technology 8 bit Embedded Microcontroller.

In an embodiment, the expansion unit 22 may include a multiplexer (“mux”) 28 to communicate and process information between the inputs 24 and the processor 26. The mux 28 may receive a plurality of inputs 24 and communicate the input signal information to the processor over a connection that utilizes few wires than the number of inputs. The multiplexer may be any appropriate size, such as a 4-bit multiplexer capable of receiving up to 16 inputs, or any other size to receive the necessary number of inputs 24.

The processor 26 may include a plurality of outputs. The outputs may include various indicator outputs, including indicators related to specific inputs 30, a timer indicator 32, and a power on indicator 34.

The processor 26 may further include a relay output 36. The relay output 36 may communicate the presence of a fault or stop condition to stop the drive 16. For example, when an input 24 is received, indicating the presence of a fault or unwanted condition, the processor 26 may activate the relay output 36. The relay output 36 may then directly or indirectly cut power to the driver 16 until the fault has been removed and cleared. Once the fault condition is removed, the relay output 36 may be reset by pressing the reset input button 25.

The processor 26 may allow predetermined inputs that would otherwise indicate a fault to remain active during a startup without triggering a fault and activating the relay output 36. For example, the Low Suction Pressure, Low Discharge Pressure, Low Engine Oil Pressure, and Low Compressor Oil Pressure limits may be exceeded during the startup of the system, after the reset button 25 is pressed. The processor 26 may allow such conditions to remain for a predetermined amount of time, such as 5 seconds without stopping the system. The startup time delay may be configurable to a desired time length. For example, a series of dual in-line package (DIP) switches 38 may be connected to the processor 26 to allow a user to select the desire time delay length. It will be appreciated, however, that other time selection means may be used in place of the DIP switches.

The relay output 36 may be utilized differently depending on the type of driver starter 20 used by the compression system 10. For example, in a system that includes a key/ignition driver starter 20, the relay output may be tied directly to the ignition signal to cut the ignition signal during the presence of a fault or restart the driver 16 once the fault is cleared. In a system that includes a push button and motor starter 20, the relay output 36 may be tied to the motor starter to disengage the motor starter relay and cut power to the driver 16 during the presence of a fault condition and reengage the motor starter relay and restart the driver 16 once the fault is cleared. In a system that includes an automated driver starter 20, the relay output 36 may be wired as an input to the automated starter 20. The automated driver starter 20 may be programmed to cut power to the driver 16 when the relay output signal is received.

The expansion unit 22 may include a demultiplexer (“demux”) 40 to interface between the processor 26 and the outputs. The demux 40 may receive a signal from the processor 26 and decode the appropriate output signal or signals to be activated. The demux 40 may be any appropriate size, such as a 4-bit demux capable of decoding up to 16 outputs, or any other size to process the necessary number of outputs.

The expansion unit 22 may be intrinsically safe to ensure a no-spark environment. For example, the inputs 24 may be electrically isolated from the processor to prevent any potential for a spark. Unlike many systems that use mechanical relays, the expansion unit 22 may include optical couplers 42 between the inputs and the processor. Instead of relaying an electrical signal over a mechanical switch like a standard relay, the optical couplers 42 may communicate the presence an input signal between an optical transmitter and an optical receiver. The transmitter may include an LED or other similar light source to signal presence of an input condition to the receiver. Upon sensing the light from the LED or light source, the receiver may then provide the appropriate signal to the multiplexer 28 or processor 26. By electrically isolating the inputs, the risk of a spark in a volatile environment, such as a natural gas compression station, may be avoided. Further, by utilizing intrinsically safe components, the expansion unit 22 may be mounted in a standard-type enclosure while still maintaining its necessary hazardous area rating.

The opto-couplers 42 may provide a further benefit by isolating the processor from electrical noise. Compression systems often experience substantial noise and vibration from the driver, compressor, and other various components. Mechanical relays may be susceptible to such noise which may trigger false inputs. While filters and the like may be used to reduce such noise, a better solution is to isolate the processor input channels from the noise altogether. This may be achieved by use of the opto-couplers 42, which provide isolation between the input devices and the processor input channels, and thus isolate the processor from any electrical noise and false inputs.

The expansion unit 22 may be configured to store a history of faults and input conditions. The history may assist with troubleshooting errors and faults on the compression system 10. The expansion unit 22 may include a memory to store a history of received inputs. In an embodiment, the processor 26 may include an on-board memory, such as EEPROM, to store a predetermined number of received input conditions. The EEPROM provides a non-volatile memory that maintains stored data even after power is lost. In an embodiment, the processor 26 may be configured to store the four most recent input fault conditions received. It will be appreciated, however, that the processor 26 may include any amount of memory and be configured to store any appropriate number of input fault conditions.

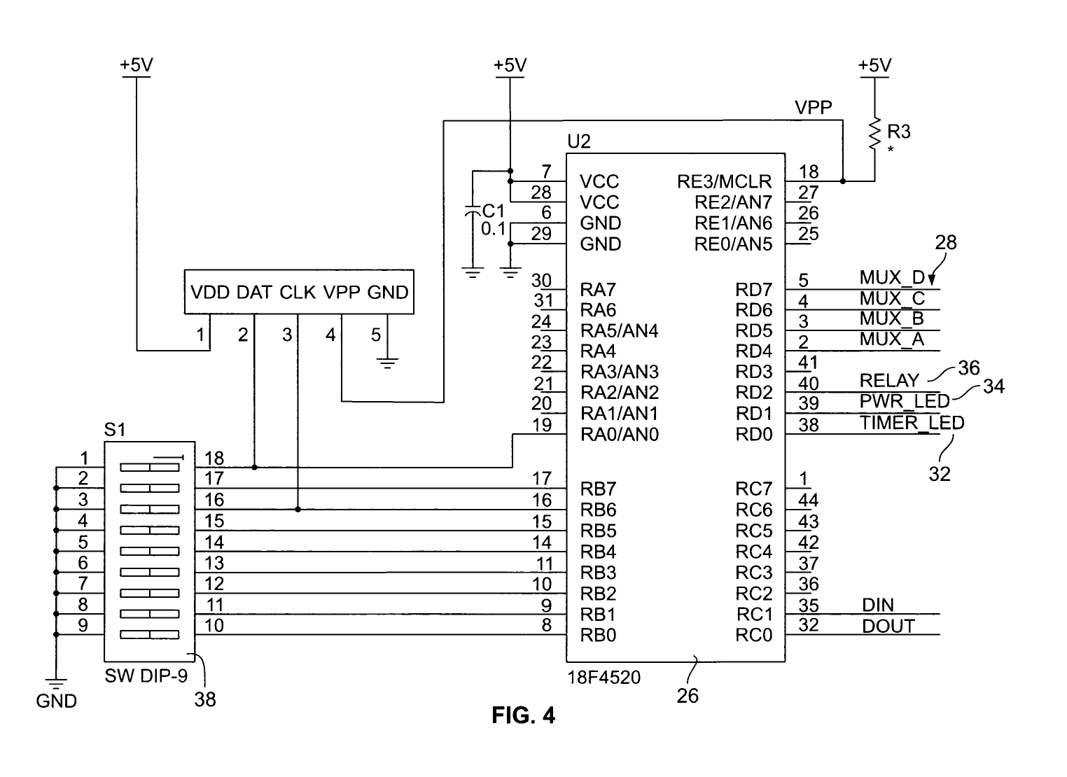

The expansion unit 22 may include an indicator display panel 44, as shown in FIG. 4. The indicator display panel 44 may comprise a plurality of indicators, such as LEDs or other lights or indicators. It will be appreciated that the panel 44 may further include other display means, such as an LCD display or other display screen. Each indicator may be labeled with the appropriate corresponding input, as shown in FIG. 4. When an input is activated, the corresponding indicator is lit. The indicator may remain lit until the fault is cleared by pressing the reset button.

The indicator display panel 44 may be used to display the stored fault history. For example, the expansion unit 22 may include an input to place the display panel 44 into a history display mode. This may be done by holding the reset button 25 for a predetermined length of time. Once the display panel 44 is in history mode it will display the most recent fault received by activating the LED that corresponds to the input that triggered the fault. Each subsequent time the reset button 25 is pushed while in history mode, the display panel 44 will light the LED that was responsible for the previous fault. The display panel 44 will cycle through as many fault conditions as are stored in the history.

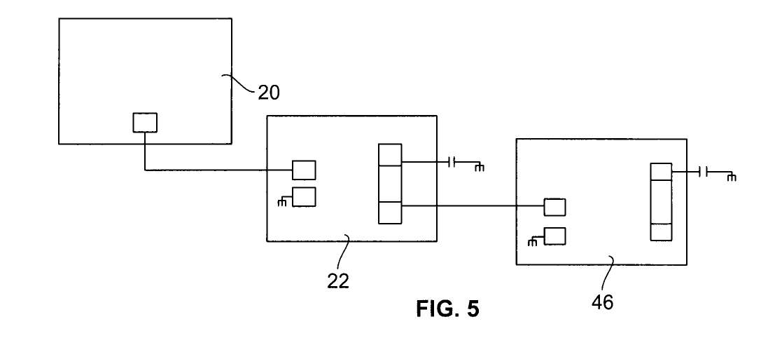

The input expansion units 22 may be stackable to provide addition input and history as necessary for a system. As shown in FIG. 5, a first expansion unit 22 may be wired to interface with the driver starter 20. A second input expansion unit 46 may be placed in series with the first expansion unit 22 to provide additional input capacity. The relay output 36 of the second expansion unit 46 may be wired to a select input of the first expansion unit 22. The first expansion unit 22 may then read any input received from the second expansion unit 46 as a fault condition and send the appropriate signal to the driver starter 20. Additional expansion units 22 may also be added and stacked in a similar manner.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, the following is claimed:

1. A gas compression system comprising:
a driver;
a driver starter;
an input expansion unit in communication with the driver starter, the input expansion unit comprising:
a processor configured to receive a plurality of input signals to monitor the compression system and send an output signal to the driver starter to start or stop the driver in response to a received input signal; and
an indication panel configured to indicate the presence of an input condition;
wherein the input expansion unit is configured to store a history of received input signals and display the history on the indication panel upon request.

2. The gas compression system of claim 1 further comprising an optically isolated switch positioned between one or more of the plurality of inputs and the processor.

3. The gas compression system of claim 1, wherein the input expansion unit includes a non-volatile memory configured to store the history.

4. The gas compression system of claim 1, wherein the driver starter is configured to receive a plurality of inputs to start and stop the drive.

5. The gas compression system of claim 4, wherein the driver starter includes an encoder input from the driver.

6. The gas compression system of claim 5, wherein the driver starter system includes one or more configurable parameter limits based on the encoder input, and wherein the drive start system is configured to stop the driver in response to an encoder input exceeding a preset parameter.

7. The gas compression system of claim 1, wherein the driver is an electric motor.

8. The gas compression system of claim 1 further comprising a second input expansion unit.

9. The gas compression system of claim 8, wherein the second input expansion unit sends an output signal to an input of the first input expansion unit.

10. The gas compression system of claim 1, wherein the indicator panel comprises a plurality of indicators.

11. The gas compression system of claim 10, wherein the indicator panel includes one indicator corresponding to each input.

12. The gas compression system of claim 1 further comprising a reset input button, wherein actuation of the reset input button clears an input condition and stores the input condition in the history.

13. The gas compression system of claim 12, wherein actuation of the reset button allows the driver to restart.

14. The gas compression system of claim 1, further comprising an input button to alter the indication panel to display the history.

15. The gas compression system of claim 1, wherein the input expansion unit includes a timer that is actuated upon reset of an input condition, and wherein the processor is configured to ignore one or more input conditions during the timer cycle.

16. A gas compression system comprising:
a driver;
a driver starter;
an input expansion unit in communication with the driver starter, the input expansion unit comprising:
a processor configured to receive a plurality of input signals to monitor the compression system and send an output signal to the driver starter to start or stop the driver in response to a received input signal; and
an indication panel configured to indicate the presence of an input condition;
wherein one or more of the plurality of input signals is electrically isolated from the processor.

17. The gas compression system of claim 16, wherein the input expansion unit is configured to store a history of received input signals and display the history on the indication panel upon request.

18. The gas compression system of claim 16, further comprising an optical switch between an input signal and the processor.

19. The gas compression system of claim 16, wherein the input expansion unit further includes one or more indicators configured to indicate the presence of an input signal.

20. The gas compression system of claim 16, wherein the driver starter includes one or more user configurable parameters.
